(19) United States
(12) Patent Application Publication
(10) Pub. No.: US 2010/0062110 A1
(43) Pub. Date: Mar. 11, 2010

(54) In-Line Continuous Flow Process for Making Cheese

(75) Inventors: Peter Dudley Elston, Palmserston North (NZ); Graham Peter Davey, Palmserston North (NZ); Peter Gilbert Wiles, Palmserston North (NZ)

Correspondence Address: KNOBBE MARTENS OLSON & BEAR LLP, 2040 MAIN STREET, FOURTEENTH FLOOR, IRVINE, CA, 92614, US

(73) Assignee: FONTERRA CO-OPERATIVE GROUP LIMITED, Auckland (NZ)

(21) Appl. No.: 12/515,518

(22) PCT Filed: Nov. 20, 2007
(86) PCT No.: PCT/NZ07/00340

§ 371 Date: Sep. 30, 2009

(30) Foreign Application Priority Data
Nov. 20, 2006 (NZ) 551402

(51) Int. Cl. A23C 19/024; A23C 19/068

(52) U.S. Cl. 426/39

(57) ABSTRACT

The invention provides a novel process of making cheese including a quick and efficient coagulation step forming discrete form and uniform curd particles in an in-line continuous flow process, separation of the curd particles from the whey and subsequent processing to produce a desired soft, semi-soft, hard or extra hard cheese.

### FIELD OF THE INVENTION

The present invention is directed to a continuous process for making cheese or a cheese curd useful in cheese making, particularly, although by no means exclusively, to a continuous process of making a mozzarella or mozzarella-like cheese.

### BACKGROUND OF THE INVENTION

Traditional cheese making generally involves the preparation of a cheese curd formed by coagulated milk proteins (particularly casein). Coagulation of cheese milk can be achieved by acidifying (to a pH between 5.0 and 6.0), either by direct addition of an acidulant or by addition of an acidified dairy stream formed by fermentation using a starter culture, or by a combination of both treatments. Coagulating enzymes (such as rennet) may be added to enhance coagulation. The resulting coagulum is cut and the whey drained off to obtain the cheese curd. The cheese curd, together with a variety of possible additives, is cooked with shear to produce a homogenous mass and cooled to produce cheese. Different types of cheese are made by varying this process as is known in the art, for example, mozzarella cheese may be made by working and stretching the molten mass prior to cooling.

The time taken to coagulate the milk protein and drain the coagulum to produce the cheese curd represent rate-limiting steps in the cheese-making process.

In WO2003/069982, Johnston et al. disclose a direct and flexible cheese making process wherein a milk stream is allowed to be renneted without forming a coagulum (for about 16 hours), which is then acidified and in-line cooked to produce curds and whey. However, this process is limited by the slow renneting step.

Attempts to speed up the production of cheese curd have, to date, met with limited success. The coagulation time is dependent upon the coagulation conditions, ie coagulating enzyme concentration, temperature, pH and salt concentration. The coagulation time can be reduced by increased temperature, increased amount of coagulating enzyme and/or reduced pH. An alternative method of increasing the speed of the coagulation step is “cold renneting”. This method recognises that the enzyme reaction can be uncoupled from the coagulation process.

In this method, the coagulating enzyme is admixed with a cheese milk and held at a low temperature (5-15° C.) to allow the reaction to proceed without the formation of a coagulum. As the temperature is increased to around 40° C., coagulation proceeds very rapidly within seconds. However, the initial enzyme reaction may take between 6-20 hours. Such a coagulation system cannot be applied to continuous cheese-making processes as, whilst the coagulation step is very rapid, the enzyme reaction step takes a long time and requires large volumes to be stored whilst the reaction proceeds. In order to maximise the efficient production of cheese curd, it would be advantageous to increase not only the coagulation per se, but also the enzyme reaction time in a manner that could be applied to a continuous cheese-making process and which does not require any bulk storage. Other methods of rapid coagulation have been attempted in continuous processes. For example, DE 1582979 (Schulz) first acidified milk and achieved coagulation quickly through heating during continuous flow through thin tubes. DE 1792264 (Roiner) describes another fast coagulation method whereby cheese milk is acidified at the coagulation temperature before the addition of rennet, after which coagulation occurs within a few seconds or minutes during continuous flow through a coagulator tube. U.S. Pat. No. 5,429,829 describes a process whereby skim milk is coagulated continuously using added acid, a coagulating enzyme and calcium chloride and heated to 48-88° C. for sufficient time for coagulation to occur. The curd is fractured into curds and whey in the flow device and held for 1 to 20 minutes to cook the curds. The curds are then mechanically separated from the whey. U.S. Pat. No. 4,499,109 describes a tubular approach where renneted milk is rested for a period at 25 to 50° C. in a section of pipe and allowed to coagulate and form a gel which is then discharged as a solid plug by further incoming milk.

However these rapid coagulation processes have not been industrially applied as it is highly unlikely that such processes could produce a precise and uniform coagulum as uniform coagulation would be very difficult to control. In addition, the apparatus used in these continuous processes are generally complicated (eg multi-tube plants).

It is an object of the present invention to provide a continuous process for producing a fast cheese curd using simple processing equipment on a commercial scale, and/or to provide the public with a useful choice.

### SUMMARY OF THE INVENTION

The invention provides a continuous process for making cheese comprising the steps
a) adjusting the temperature of a protein containing starting milk to between about 5° C. and 25° C.;
b) acidifying the temperature adjusted starting milk of step a) to reduce the pH to between about 4.6 and 6.2;
c) adding an enzyme capable of converting kappa casein into para-kappa casein to the acidified, temperature adjusted starting milk of step b) and mixing rapidly to evenly disperse the enzyme throughout the starting milk;
d) passing the mixture of step c) through a flow device for between about 1 and 1000 seconds to allow the enzyme to react with the milk protein;
e) heating the enzyme-reacted mixture of step d) to between about 30° C. and 55° C. to initiate coagulation and produce discrete curd particles within the flow device;
f) draining the curd particles from the whey; and
g) further processing the curd particles to make a cheese product.

The protein containing starting milk may comprise milk or reconstituted milk selected from the group comprising whole fat milk, whole milk retentate/concentrate, semi-skimmed milk, skimmed milk, skimmed milk retentate/concentrate, buttermilk, buttermilk retentate/concentrate or whey protein retentate/concentrate or from products made from milk as would be appreciated by a skilled worker or combinations thereof.

The temperature of the starting milk may be adjusted to between 10° C. and 22° C., and more preferably to between 12° C. and 20° C. in step a).

The temperature adjusted starting milk of step a) may be acidified using an acidulant selected from the group consisting of a food grade acid (eg hydrochloric, sulphuric, acetic or lactic acid) and a fermentate (eg a dairy growth medium stream to which starter culture has been added) to a pH of between 5.0 and 6.0, most preferably to between 5.2 and 6.0. It is also possible to use a combination of a food grade acid and a fermentate.

The enzyme added at step c) may be Chymosin or Rennin or any other suitable bacterial or vegetable derived protease. For example, a bacterially derived proteolytic enzyme is Fromase XL₇₅₀ (DSM Food Specialities, Heerten, Netherlands), or ChyMax (Chr. Hansen, A/S, Hoersholm, Denmark).

The enzyme containing starting milk at step c) is pumped into a flow device in step d) for a period sufficient to allow the enzyme to react with the milk protein. The flow device may comprise a tubular flow passage or arrangement of flow-linked vessels whose volumetric capacity provides sufficient residence time for the reaction to occur. Preferably the residence time is about 10 and 500 seconds, more preferably between about 20 and 400 seconds. The temperature of the enzyme containing starting milk is less than the temperature at which it will coagulate (ie less than 28° C., and preferably less than 20° C.).

Once the enzyme has reacted with the protein in the starting milk, the starting milk is heated/cooked to a temperature of between about 30° C. and 50° C., preferably around 40-46° C., using direct or indirect heating means to coagulate the protein and form coagulated curd particles.

The coagulated curd particles/whey mixture is passed to a separator such as a sieve or decanter and the curd is further processed to produce a cheese product.

The cheese product may comprise a soft, semi-soft, hard or extra-hard cheese including cheddar, gouda, parmesan and mozzarella cheese.

### DESCRIPTION OF THE FIGURES

The present invention will now be described with reference to the figures of the accompanying drawings in which:

FIG. 1 shows a schematic drawing of the process of the present invention;

FIG. 2 shows a flow diagram of the process of the present invention;

FIG. 3 shows a residence time distribution plot for the configuration of FIG. 2;

FIG. 4 shows a residence time distribution plot, in single and triple stirred test reactors;

FIG. 5 shows an SDS-PAGE electrophoresis gel of milk/curd samples taken before, during and after the process of the present invention;

FIG. 6 shows a cooked pizza using a mozzarella cheese prepared by the process of the invention; and

FIG. 7 shows a cooked pizza using a control mozzarella cheese.

### DETAILED DESCRIPTION OF THE INVENTION

The present invention provides a fast continuous process for making cheese including a quick and efficient coagulation step forming discrete firm and uniform curd particles. The curd particles can be further processed by known processes to produce a soft, semi-soft, hard or extra hard cheese.

The advantages of the novel process of the present invention include the ability to produce a variety of cheeses rapidly and cost effectively on a commercial scale.

The process uses a relatively simple apparatus that is easily controlled to rapidly produce a consistent, homogeneous curd.

In traditional cheese making, renneting is carried out at temperatures that initiate coagulation (˜30° C.) at neutral pH. Whilst it is known that a decrease in pH can increase rennet kinetics and itself induce coagulation, it is difficult to reduce the pH of milk directly at 30° C., as this would result in localised acid precipitation of the casein. pH is usually lowered in such traditional processes slowly via acid producing bacteria. Alternatively, coagulation may be accelerated by increasing the temperature up to 55° C. Cold renneting methods usually involve renneting overnight at 10° C.

The present invention has surprisingly found that cold renneting can be significantly accelerated by carrying out at a slightly higher temperature range than usual (between 12° C. and 20° C.) when the pH for the milk is reduced to below 6.0. Coagulation takes place in less than 15 minutes, preferably in less than 10 minutes, more preferably in less than 5 minutes, and most preferably around 1 minute.

In a first embodiment; the present invention provides a continuous process for making cheese comprising acidifying a cooled (5° C. to 25° C.) pasteurised and standardised starting milk to a pH within a range between 4.6 and 6.2, adding a coagulating enzyme at a temperature which suppresses the formulation of a coagulum and mixing rapidly to distribute the enzyme evenly throughout the starting milk, passing the milk containing coagulating enzyme solution along a flow path for a residence time of between 1 and 1000 seconds and heating said solution to between 30° C. and 55° C. while inducing controlled turbulence in the solution to cause coagulation of the protein into small curd particles within the flow, separating the curd particles of coagulated protein from the whey liquid and further processing the curd to make a cheese product.

The curd particles may, for example, be mechanically worked, ie. stretched, and heated at 50° C. to 90° C., shaped and cooled to produce a mozzarella or mozzarella-like cheese.

The curd may be mechanically worked immediately while still fresh, or may be frozen and/or dried, and thawed and/or reconstituted before mechanically working.

Preferably, the invention provides a process of making cheese comprising steps of:
a) adjusting the temperature of a protein containing starting milk to between about 5° C. and 25° C.;
b) acidifying the temperature adjusted starting milk of step a) to reduce the pH to between about 4.6 and 6.2;
c) adding an enzyme capable of converting kappa casein into para-kappa casein to the acidified, temperature adjusted starting milk of step b) and mixing rapidly to evenly disperse the enzyme throughout the starting milk;
d) passing the mixture of step c) through a flow device for between about 1 and 1000 seconds to allow the enzyme to react with the milk protein;
e) heating the enzyme-reacted mixture of step d) to between about 30° C. and 55° C. to initiate coagulation and produce discrete curd particles within the flow device;
f) draining the curd particles from the whey; and
g) further processing the curd particles to make a cheese product.

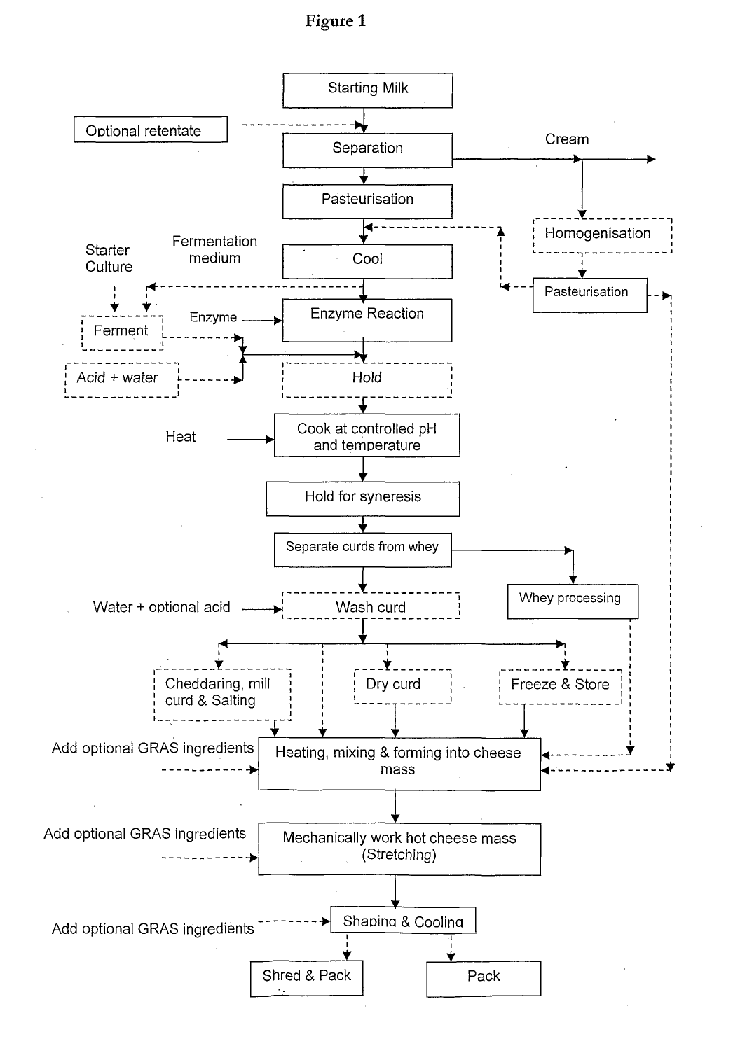

The general steps of this preferred process are set out in FIG. 1 and are performed in the recited order. Alternatively, steps b) and c) may be carried out simultaneously, or optionally reversed. Preferably the two reagents (ie. acidulant and enzyme) are dosed into the milk stream within a few seconds of each other. Good mixing of each reagent with the milk stream is preferred.

The cheese made by this process may comprise a soft, semi-soft, hard or extra hard cheese including cheddar, cheddar-like cheese, gouda, gouda-like cheese, parmesan, parmesan-like cheese, mozzarella and mozzarella-like cheese.

The starting milk may be selected from one or more of the group comprising whole fat milk; whole milk retentate/concentrate; semi skimmed milk; skimmed milk; skimmed milk retentate/concentrate; buttermilk; buttermilk retentate/concentrate and whey protein retentate/concentrate or from products made from milk as would be appreciated by a person skilled in the art. One or more powders, such as whole milk powder, skimmed milk powder, milk protein concentrate powder, whey protein concentrate powder, whey protein isolate powder and buttermilk powder or other powders made from milk, reconstituted or dry, singularly or in combination may also be selected as the starting milk or be added to the starting milk.

The starting milk may be sourced from any milk producing animal.

The protein and fat composition of the starting milk may be altered by a process known as standardisation. The process of standardisation involves removing the variability in the fat and protein composition of the starting milk to achieve a particular end cheese composition. Traditionally, standardisation of milk has been achieved by removing nearly all the fat (cream) from the starting milk (separation) and adding back a known amount of cream thereto to achieve a predetermined protein/fat ratio in the starting milk. The amount of fat (cream) required to be removed will depend upon the fat content of the starting milk and the required end cheese composition. Preferably, the starting milk has a fat content of at least 0.05%. If higher fat contents are required a separate side stream of homogenised cream may be added to raise the fat content of the starting milk as would be appreciated by a skilled worker. Additionally or alternatively, the protein concentration may be altered by adding a protein concentrate such as a UF retentate or powder concentrate to a starting milk composition, or by any other method as would be appreciated by a person skilled in the art.

The starting milk of step a) may be pasteurised. Pasteurisation of the starting milk takes place under standard conditions, namely, heat treating the milk at a temperature and time sufficient to kill pathogens, (typically 72° C. for 15 seconds). The starting milk may be pasteurised before or after step a), or pasteurisation may take place during the heating at step e) or during further processing at step g).

The pH of the temperature adjusted starting milk is reduced in step b) by adding a separate growth medium stream (such as skimmilk, skimmilk retentate or any other suitable commercially available growth medium such as VIS-START (Danisco Cultar, Denmark)) to which bulk starter culture has been added, and/or an acidulant directly into the cold starting milk in order to lower the pH of the milk composition to a level of 4.2 to 6.2.

The starter culture to be added to the separate growth medium stream can be mesophilic or thermophilic or a mix and added at 0.0005 to 5%, preferably 0.01 to 0.2%, most preferably 0.1% of the milk volume. Examples of starter cultures are: Streptococcus themophilus, Lactobacillus bulgaricus, Lactobacillus helveticus, Lactococcus lactis subspecies cremoris, Lactococcus lactis subspecies lactis.

A starter culture stream is prepared by heating a growth medium, preferably skimmilk (or skimmilk retentate, or reconstituted skim milk) to approximately 26° C., adding the culture and allowing fermentation to proceed until the pH of the skimmilk has reached pH 4.5-6.7, preferably pH 4.6.

Once the skimmilk stream has reached the target pH, it can either be cooled to <22° C. or mixed with the cold starting milk stream. Where the two streams are combined, a further step of mixing and holding the two streams is required, typically for 1 to 20 minutes.

Where direct acidification is required, sufficient acidulant (preferably a food grade acid such as an organic acid) at an appropriate dilution is added and mixed to reduce the pH of the cold starting milk to between pH 4.2 and 6.2, preferably to between pH 5.0 and 6.0, and more preferably to between pH 5.2 and 6.0.

Preferably the acidulant is a food grade acid such as lactic acid, acetic acid, hydrochloric acid or sulphuric acid and, after dilution with water to approximately 1-10% w/w, is added to the cooled starting milk.

It is also possible to use a combination of direct acidification and addition of a side stream of growth medium to which a starter culture has been added to reduce the pH of the cold starting milk composition to the target pH as would be appreciated by a skilled person.

Once the target pH of the cold starting milk has been reached, a coagulating enzyme is added and the mixture vigorously stirred to evenly distribute the enzyme. At this stage the milk composition is pumped through a plant and subjected to in-line treatment. The starting milk composition, containing coagulating enzyme is incubated in-line under conditions which will not allow the formation of a coagulum, typically at a temperature of <28° C., preferably between 8 and 20° C., more preferably between 12 and 20° C., at a suitable concentration of coagulating enzyme for sufficient time to cleave the bond of the kappa-casein to form para-kappa-casein and to expose casein micelles. Typically, this incubation period is for 1 to 1000 seconds. The coagulation enzyme may be Chymosin or Rennin or any other suitable proteolytic enzyme such as Fromase XL₇₅₀ (DMS Food Specialities, Heerten, Netherlands) or ChyMax (Chr. Hansen, A/S, Hoersholm, Denmark).

The in-line treatment or flow path may consist of a flow tube with a volumetric capacity to provide the required reaction time. Alternatively, the flow path may consist of one or more vessels whose combined volumetric capacity provides the required reaction time. Preferably, when a plurality of vessels is used they are combined to provide a single continuous flow path. Preferably said vessels are well mixed.

In step e), the milk composition is heated/cooked to a temperature of 30 to 55° C. by using direct or indirect heating means to coagulate the protein and form coagulated curd particles. In the case of direct heating, steam can be injected into the liquid milk composition flow and in the case of indirect heating, a jacketed heater or heat exchanger is associated with the flow path along which the liquid is being pumped. The temperature is increased to an upper limit which will be consistent with the parameters of the process, for example up to 55° C. and the flow rate is high inducing controlled substantial turbulence into the liquid being passed therealong. This prevents any large build up of curd and means that the protein coagulates into small curd particles.

It is necessary to allow time for the reaction to advance to the desired degree and typically, the milk composition is passed to an enclosed stainless steel holding tube for between 10 and 50 seconds to complete the coagulation. The coagulated curd particles/whey mixture is passed to a separator to separate the curd from the whey. Preferably, the separator may comprise a sieve or decanter or the like, but could also include membrane separation apparatus.

If washing is required the coagulated curd particles/whey mixture may be first pumped to a wash vat and washed in warm, acidified (pH 3.0 to 5.4), potable water before being passed to the separator. This wash step has the dual purpose of removing excess whey from the curd as well as adjusting the mineral content of the curd. Mineral adjustment, and particularly calcium adjustment, is a critical step in the cheese-making process as the calcium content of the end cheese product affects the functionality and compositional characteristics of the cheese. In general, the present process, and especially the wash step, allows a cheese product to be produced with a lower calcium content than can be achieved using a traditional cheese making process where the curd is coagulated over a long period of time and generally in a solid mass.

Alternatively, or additionally, washing may take place after the coagulated curd particles have been collected in the separator.

The amount of whey separated is dependent upon the desired moisture content of the final cheese product, however, moisture content is also controlled at other stages in the process, such as by the addition of water during the further processing step g), so that the present process is able to produce cheese having a higher moisture content than the corresponding cheeses made by traditional processes.

The dewheyed or washed and dewatered curd may be stored before subsequent processing, thus effectively decoupling the end process from the milk supply.

Alternatively, the separated curd particles may be further processed immediately to produce a desired cheese product.

Further processing may involve heating and stretching the curd particles to form a mozzarella or mozzarella-like cheese, or the curd particles may be allowed to knit together to form a ‘chicken-breast’ structure, a process that results in a continuous mat of curd, known as “cheddering”. Alternatively the curd may be dry stirred and/or pressed in block form. The time required for the curd to knit together in a solid mass is dependant on the acidification method used, the cooking temperature and the milling pH target as would be understood by a skilled artisan.

After cheddaring the curd may be milled or ground. Milling/grinding involves cutting the mat of cheddared curd into finger-sized pieces of curd or smaller which can be easily and effectively salted.

In more traditional cheese making processes only a portion of the salt is added at this point or none at all. In these cases salt is added during other further processing steps, such as, for example, during stretching and/or brining after stretching.

If salt is added after milling, time is allowed for the salt to penetrate the curd (mellowing).

The curd may be optionally frozen and/or dried before further processing, for example, the curd may be frozen and/or dried before or after the milling/grinding step but before it is heated and stretched. Such frozen curd is then thawed before stretching. If the curd is dried, for example by using a fluid bed drier, a belt drier, a tray drier or a ring drier, dried curd may be reconstituted before stretching. Alternatively, the curd may be partially dried before stretching and such partially dried curd may not require reconstituting before stretching depending on the water content of the partially dried curd and the desired water content of the final cheese as would be appreciated by a skilled worker.

When the curd particles are heated and stretched, the curd is heated to a temperature of between about 50° C. and 90° C. either by immersing the curd in hot water or hot whey as in the traditional method, or by heating and stretching in a dry environment as described in U.S. Pat. No. 5,925,398 and U.S. Pat. No. 6,319,526. In either method, the curd is heated and stretched into a homogenous, plastic mass. Preferably the curd is heated to a curd temperature of between about 50° C. to 75° C. using equipment common in the art, such as a single or twin screw stretcher/extruder type device or steam jacketed and/or infused vessels equipped with mechanical agitators (waterless cookers).

Traditionally the hot stretched curd is immediately extruded into moulds or hoops and the cheese cooled by spraying chilled water/brine onto the surface of the hoops. This initial cooling step hardens the outside surface of the block providing some rigidity. Following this initial cooling the cheese is removed from the moulds and placed in a salt brine (partially or completely saturated) bath for a period of time to completely cool the cheese and enable uptake of the salt to the required level. Once cooled the cheese is placed in plastic liners, air removed and the bag is sealed. Alternatively, hot stretched curd may be extruded into sheet-like or ribbon-like form and directly cooled without moulding.

An alternative process sometimes used in commercial practice is to completely dry salt the curd, mellow, stretch and pack directly into plastic liners contained in hoops and the liners sealed. The hoops plus cheese are then immersed in chilled water.

Cooled cheese is stored at between 2° C. to 10° C. Once ready for use the cheese may be used directly or the block frozen or the block shredded and the shred frozen.

Where the hot stretched curd is extruded as a ribbon or sheet, which provides rapid cooling, shredding and freezing of the shred may take place in-line, immediately following stretching and cooling.

Other GRAS (generally accepted as safe) ingredients common to the cheese making process may be added at any suitable step in the process as would be appreciated by a person skilled in the art. GRAS ingredients include non-dairy ingredients such as stabilisers, emulsifiers, natural or artificial flavours, colours, starches, water, gums, lipases, proteases, mineral and organic acid, structural protein (soy protein or wheat protein), and anti microbial agents as well as dairy ingredients which may enhance flavour and change the protein to fat ratio of the final cheese. In particular, flavour ingredients may comprise various fermentation and/or enzyme derived products or aged cheese or mixtures thereof as would be appreciated by a skilled worker. Preferably, such GRAS ingredients may be added after the curd has been milled and/or during the “dry” stretching step; and/or to the extruded sheet-like or ribbon-like hot stretched curd; and mixed or worked into the curd to disperse evenly. Alternatively, GRAS ingredients may be added to the starting milk, during acidification, or to the separated coagulated curd particles as would be understood by a skilled worker. The flexibility of allowing any combination of additives to be added at any step in the process allows the final composition of the cheese to be precisely controlled, including the functionality characteristics.

In a further embodiment, the present invention provides a soft, semi-soft, hard or extra hard cheese product produced by the processes of the invention.

In a further embodiment, the present invention provides a mozzarella or mozzarella-like cheese product produced by the processes of the invention.

The present invention also provides a food product comprising the mozzarella or mozzarella-like cheese of the present invention, such as a pizza.

Any ranges mentioned in this patent specification are intended to inherently include all of the possible values within the stated range. For example, a range 1 to 10 is intended to incorporate all related numbers within the range, ie. 1, 1.1, 2, 3, 3.9, 4, 5, 6, 6.5, 7, 8, 9 and 10, and also any range of rational numbers within that range (for example, 2 to 8, 1.5 to 5.5 and 3.1 to 4.7) so that all subranges of all ranges expressly disclosed herein are expressly disclosed. These are only examples of what is specifically intended and all possible combinations of numeral value between the lowest value and the highest value enumerated are to be considered to be expressly stated in this application in a similar manner.

The term ‘comprising’ as used in this specification and claims means ‘consisting at least in part of’, that is to say when interpreting statements in this specification and claims which include that term, the features, prefaced by that term in each statement, all need to be present but other features can also be present.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples.

### Example 1

### Initial Laboratory Bench Trial

The following parameters were used for the laboratory trial:
Low fat fresh skim milk with pH 6.73
200 mL of skim milk sample was used for each trial.
Two setting temperatures were used 12° C./20° C.
Three milk/pH adjustments and a control milk were used i.e. pH 5.4, 5.7, 6.0 and 6.73 (control).
A rennet enzyme level of approx 1.0 L to 20,000 L of skim milk (Renco® liquid natural calf rennet [activity 280 IMCU/mL], Dairy Meats N.Z. Ltd., Enzyme Division, Eltham, New Zealand) was used.
All samples were timed to form a coagulate (clot) suitable for conversion into curds and whey.

### Results

Table 1 gives a summary of the outcome of 8 laboratory experimental trials as proof of concept.

TABLE 1
Clotting times for pH-adjusted milks at two milk-setting temperatures.

| | Reaction | | | | | |
|---|---|---|---|---|---|---|
| Fresh | temperature | Volume | Adjusted | Enzyme | Setting | |
| skim milk | (° C.) | (mL) | milk pH | addition | time (s) | Comments |
| Control | 28 | 200 | 5.45 | 2 drops | 60 | Very Firm |
| | 28 | 200 | 5.71 | 2 drops | 100 | Very Firm |
| | 28 | 200 | 6.04 | 3 drops | 100 | Very Firm |
| | 28 | 200 | 6.73 | 2 drops | 960 | Very Firm |
| Control | 12 | 200 | 5.42 | 2 drops | 80 | Firm/Softer |
| | 12 | 200 | 5.71 | 2 drops | 110 | Firm/Softer |
| | 12 | 200 | 6.04 | 2 drops | 135 | Firm/Softer |
| | 12 | 200 | 6.73 | 2 drops | 2100 | Firm/Softer |

Note:
Acid used was 0.5N diluted H₂SO₄ for pH adjustment of milk. The natural (unadjusted) pH of the skim milk was 6.73.

Pre-adjusting the milk pH before rennet addition has a surprisingly dramatic effect on the renneted milk setting time, i.e. the setting times can be greatly reduced.
All clots formed were satisfactory for later processing into cheese curd.

### Example 2

### Pilot Plant Trial

1,800 L of skim milk (pH 6.7) was cooled to 12° C. and 450 L and 1350 L placed into small silos and four trials carried out as described below and as set out in FIG. 1.

### Trial 1 (Control)

450 L of skim milk at 12° C. was pumped to another vessel and 50 mL standard strength rennet (as above) was added (1 mL per 9 L), rapidly mixed and then allowed to react overnight. The following day, the reacted milk was pumped to the cooker. In the line carrying the milk to the cooker, acid (0.25M sulphuric acid) was added to reduce the pH to 5.45 and at the cooker steam was injected into the line to raise the temperature of the enzyme treated and acidified milk to about 43-44° C. to induce clot formation and cook the clotted milk. After a further in line holding time of about 50 s, the mixture of curds and whey were pumped into a horizontal bowl centrifugal decanter (Sharples model J83P2000, Pennwalt Corporation, Warminster, Pa.) to separate the curds from the whey. A sample of each stream was taken for analysis.

For trials 2, 3 & 4, rennet (standard strength) was diluted with deionised water (200 mL added to 90 L water).

### Trial 2

450 L of skim milk at 12° C. was pumped to another vessel and dilute (0.25M) sulphuric acid was dosed in the line connecting the two vessels to reduce the pH of the milk to 5.45. The acidified milk was then pumped into a line where diluted rennet was dosed in at the rate of 1 mL rennet (standard strength basis) per 9 L milk, rapidly mixed and allowed to flow in a pipeline of sufficient length to provide a nominal residence time of 240 s. At the end of the residence time, the reacted stream was heated in a plate heat exchanger to 20° C. and then steam was injected into the line to raise the temperature of the enzyme treated milk to about 45-46° C. to induce clot formation and cook the clotted milk. After a further in line holding time of about 50 s, the mixture of curds and whey were pumped into a horizontal bowl centrifugal decanter to separate the curd from the whey. A sample of each stream was taken for analysis. Trial 2 was repeated.

### Trial 3

450 L of skim milk at 12° C. was pumped to another vessel and dilute (0.25M) sulphuric acid was dosed in the line connecting the two vessels to reduce the pH of the milk to 5.45. The acidified milk was then pumped into a line where rennet was dosed at the rate of 1 mL (standard strength basis) per 18 L, rapidly mixed and allowed to flow in a pipeline of sufficient length to provide a nominal residence time of 240 s. At the end of the required residence time, the reacted stream was heated in a plate heat exchanger to 20° C. and then steam was injected into the line to raise the temperature of the enzyme treated milk to about 45-46° C. to induce clot formation and cook the clotted milk. The stream was then cooled to about 40° C. by passing through a Spiroflow™ heat exchanger and then the mixture of curds and whey were pumped into a horizontal bowl centrifugal decanter to separate the curd from the whey. A sample of each stream was taken for analysis.

### Trial 4

450 L of skim milk at 12° C. was pumped to another vessel and dilute (0.25M) sulphuric acid was dosed in the line connecting the two vessels to reduce the pH of the milk to 5.95. The acidified milk was then pumped into a line where rennet was dosed at the rate of 1 mL (standard strength basis) per 9 L, rapidly mixed and allowed to flow in a pipeline of sufficient length to provide a nominal residence time of about 300 s. At the end of the residence time, the reacted stream was heated in a plate heat exchanger to 20° C. and then steam was injected into the line to raise the temperature of the enzyme treated milk to about 45-46° C. to induce clot formation and cook the clotted milk. The mixture of curds and whey were pumped into a horizontal bowl centrifugal decanter to separate the curd from the whey. A sample of each stream was taken for analysis.

The skim milk had a calcium concentration of 1.24 g/kg. (All calcium concentrations were determined by an inductively coupled plasma (ICP) method.)

The results are shown in Table 2.

TABLE 2
Summary of analysis of curd and whey samples

| | Run 1 | Run 2 | | Run 3 | Run 4 |
|---|---|---|---|---|---|
| | (cold rennet, | (pH 5.45, | | (pH 5.45, half strength | (pH 5.95, |
| | pH 5.45, 43° C.) | rennet, 46° C.) | | rennet, 46° C.) | rennet, 46° C.) |
| Curd moisture (%) | 53.1 | 61.9 | 56.7 | NA | 58.4 |
| Curd solids (%) | 46.9 | 38.1 | 43.3 | NA | 41.6 |
| Curd protein (TN × 6.38) (%) | 42.8 | 32.2 | 40.3 | NA | 37.1 |
| Curd calcium (g/kg) | 8.8 | 5.7 | 6.5 | NA | 9.6 |
| Calcium/protein | 0.021 | 0.018 | 0.016 | | 0.026 |
| Whey calcium (g/kg) | 0.65 | 0.74 | 0.70 | NA | 0.47 |
| Curd recovery | Good | Good | Good | No curd able to | Good |
| | curd | curd | curd | be recovered | curd |

These results demonstrated that direct acid/rennet additions could achieve good curd with control of the curd calcium concentration using an inline flow process.

### Example 3

### Scaled Up Trials Using Triple Stirred Tanks

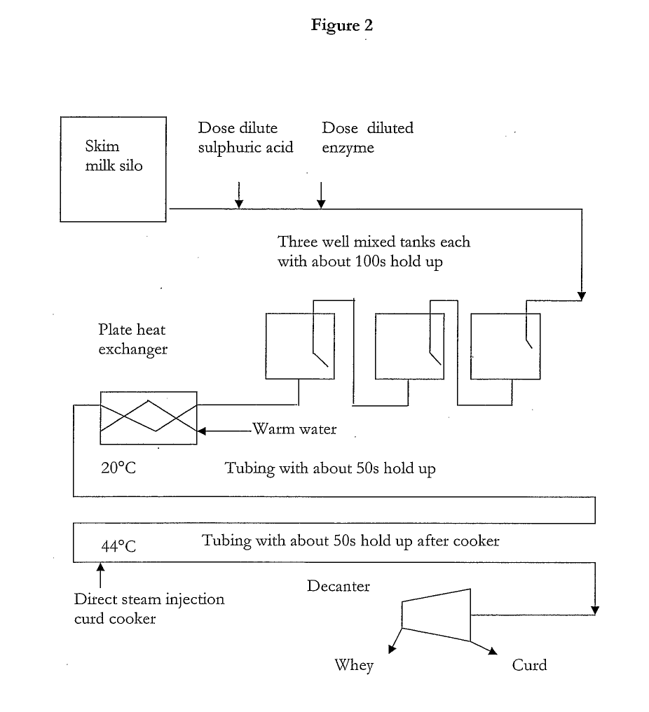

2000 L pasteurised skim milk was pumped through the plant at the rate of about 2000 L/h. The plant was configured as shown in FIG. 2. Dilute sulphuric acid (2.5% w/w) was dosed into the milk line to reduce the milk pH to the required value (either 5.4 or 5.9). The pH of the acidified milk was monitored by bleeding a small stream off into a small container holding a calibrated pH electrode.

Trials used calf rennet (as described above) or a microbially derived protease, Fromase 750 XL (approximately 800 IMCU/mL), supplied by DSM Food Specialities, Sydney, Australia. The enzymes were diluted with water prior to dosing into the milk. 300 mL of calf rennet was diluted with 20 L of water, and 100 mL of Fromase was diluted with 20 L of water. The milk clotting enzyme was dosed into the milk line at a rate to give an equivalent activity of about 36 international milk clotting units (IMCU) per litre of skim milk (at pH 6.7). After a brief hold up time of about 10 seconds, the milk entered the first of three stirred tank reactors. Each tank was well mixed by way of the turbulence and swirl created by the direction and velocity of the entering fluid and operated at a level to provide about 100 seconds of nominal hold up time. After emerging from the third tank, the milk was passed through a plate heat exchanger where the temperature of the milk was adjusted to about 20° C. with exchange against warm water. The temperature adjusted milk then passed through a further length of pipe to provide about 50 seconds of hold up. The milk then was pumped through a cooker where steam was injected into the milk line to rapidly raise the temperature to about 45° C. The heated milk then passed through a further length of pipe to allow the cooked milk to form curds and whey (about 50 seconds). The curds and whey were separated by pumping the mixture through a 0.15 horizontal bowl centrifuge (Sharples model J83P2000, Pennwalt Corporation, Warminster, Pa.). Samples were taken of the curds and whey, generally 10 min after start-up, at 20 min and 30 min.

Table 3 summarises the initial pair of comparisons.

TABLE 3
Comparison of enzymes

| | Rennet | Fromase |
|---|---|---|
| Milk temperature (° C.) | 10 | 10 |
| pH | 5.4 | 5.4 |
| Enzyme dosage in milk (IMCU/L) | 38 | 36 |
| Curd cooking temperature (° C.) | 44-45 | 44-45 |
| Curd performance | Marginal | Just satisfactory |

The initial comparison showed that both enzymes performed similarly in the reduced pH environment. It was decided that further trials would use Fromase.

The second trial compared the renneting of milk at different pH values (Table 4).

TABLE 4
Comparison of curd production at high and low pH levels

| | Fromase | Fromase |
|---|---|---|
| Milk temperature (° C.) | 15 | 15 |
| pH | 5.4 | 5.9 |
| Enzyme activity in milk | 36 | 36 |
| (IMCU/L) | | |
| Curd cooking temperature | 43-45 | 43-45 |
| (° C.) | | |
| Curd moisture (%) | 56.9, 56.8, 56.3 | 58.0, 57.6 |
| Curd protein (% wet basis | 40.0, 41.3, 39.8 | 38.9, 39.3 |
| [TN × 6.38]) | | |
| Curd calcium (mg/kg wet | 6,910, 6,830, 7,020 | 9,360, 9,510 |
| basis) | | |
| Curd performance | Satisfactory | Just satisfactory but |
| | | not very stable |

The third comparison repeated the second trial but at a higher milk temperature (Table 5).

TABLE 5
Comparison of curd production at high and
low pH using higher milk temperature

| | Fromase | Fromase |
|---|---|---|
| Milk temperature (° C.) | 20 | 20 |
| pH | 5.4 | 5.9 |
| Enzyme activity in milk | 36 | 36 |
| (IMCU/L) | | |
| Curd cooking temperature | 43-45 | 43-45 |
| (° C.) | | |
| Curd moisture (%) | 56.9, 56.8, 56.7 | 56.8, 57.0, 56.6 |
| Curd protein (% wet basis | 41.2, 41.6, 41.3 | 40.5, 40.3, 39.9 |
| [TN × 6.38]) | | |
| Curd calcium (mg/kg wet | 7,060, 6,680, 6980 | 8,830, NA, 10,400 |
| basis) | | |
| Curd performance | Commercially | Satisfactory |
| | acceptable | |

### Extent of Renneting

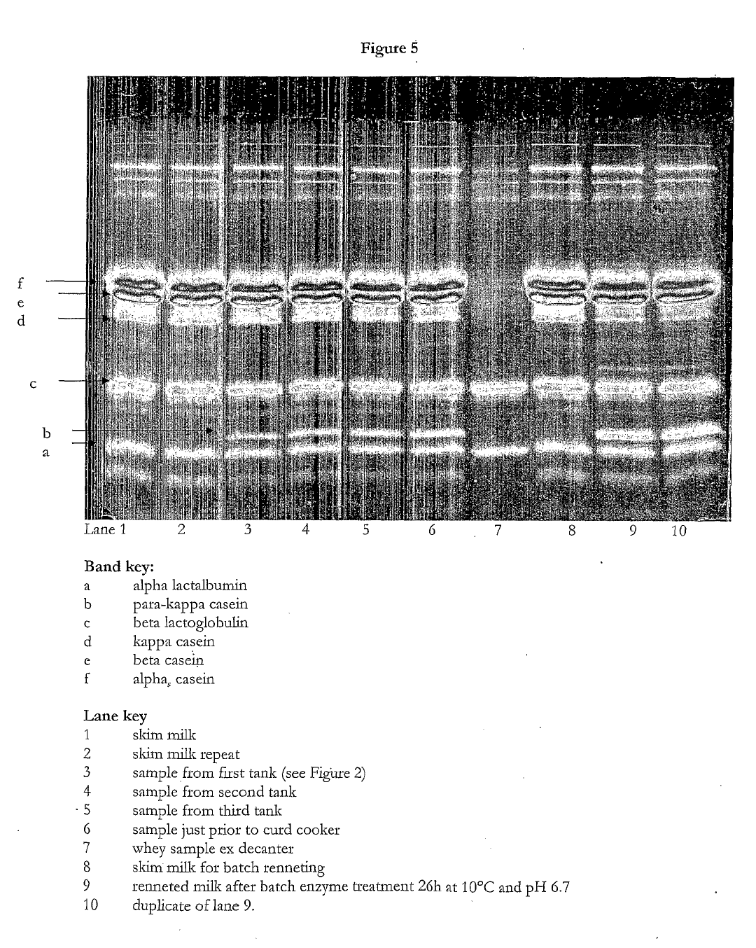

For the successful production of curd and cheese, the milk stream must be adequately renneted i.e. a sufficient conversion of kappa casein to para-kappa casein is required. This was examined by taking samples of fresh skim milk, acidified enzyme treated milk at each of the reaction tanks and prior to the curd cooker. A sample of whey taken post the decanter was also obtained. These samples were analysed by SDS-PAGE electrophoresis. A resulting gel is shown in FIG. 5.

Observation of the kappa casein lanes 1-6 showed that as the treated milk moved progressively through the flow device, the enzyme increasingly reacted with this protein and its concentration fell. Conversely the para-kappa casein lanes 1-6 showed a progressive increase in this protein as renneting theory suggests. Of interest is comparison of lane 6 with lanes 9 or 10 where the milk had been batch treated with the enzyme (26 h at 10° C. at pH 16.7)—almost all the kappa casein is noted to have been converted to para-kappa casein. The gels (Lanes 3-6) showed no undesired protein reactions (as might be evidenced by the presence of unexpected bands), despite the acid reaction conditions. By integration of the band densities, quantitatively it is indicated that at the curd cooker (Lane 6) about 60% of the kappa casein had been converted to para-kappa casein relative to the batch reacted control (Lanes 9 & 10). Further reaction can take place post the curd cooker during the approximately 50 s holding time before the curd-whey mixture reaches the decanter. The whey sample (Lane 7) clearly showed that there was insignificant casein remaining in the whey. Hence the enzyme treatment conditions of the present invention are sufficient to get a clean and nearly total separation of the casein from the whey.

### Manipulation of Curd Calcium

The concentration of calcium in the curd recovered from the decanter has consequences for the properties of the resulting cheese. Broadly, and without being bound by theory, a cheese prepared with curd having a low calcium content results in a product with a soft, elastic, pliable body with good melt and long stretch properties. The characteristics sought after in mozzarella cheese are therefore towards requiring a curd with a relatively low calcium content. Conversely a curd with a relatively high calcium content will result in a cheese with a brittle, short body that has poor melt and limited stretch properties. The manipulation of the milk pH during the period while the enzyme reaction is occurring and the curd is formed in the cooking step is the main means of a attaining the required calcium content in the final curd. Broadly a low pH (strongly acidic) milk results in a curd with a low calcium content, and a high pH (weakly acidic) milk results in a high calcium content. Accordingly, the treatments shown in Tables 4 & 5 targeted milk pH values of 5.4 and 5.9. Curd calcium concentrations were determined using standard sprectraphotometric procedures using inductively coupled plasma excitation. Curd moisture and TN levels were determined by standard oven and Kjeldahl methods respectively. The results in Tables 4 & 5 showed that the different pH treatments resulted in widely different curd calcium concentrations. These results were considered satisfactory for the means of control and manipulation of the calcium content of the curd for subsequent cheese making.

### Conversion of Curd to Cheese

A quantity of recovered curd (about 15 kg) from each of the second and third trials (at pH 5.4) was converted to batches of mozzarella cheese. The formulation used is shown in Table 6.

TABLE 6
Formulation for mozzarella cheese

| Ingredient | Quantity (kg) |
|---|---|
| Curd from pH 5.4 run using Fromase | 14.01 |
| High fat cream (80% fat) | 6.58 |
| Salt | 0.35 |
| Water (added) | 2.81 |
| Condensate from injected steam | 1.25 |
| for heating (estimated) | |
| Total | 25.0 |

Into a Blentech twin-screw horizontal cooker (Model CC45, Blentech Corporation, Rohnert Park, Calif.), the 80% fat cream, curd (pH 5.4 from run of Table 4) and salt were added and mixed for 1 minute using a screw speed of 50 rpm. Water was added and the batch mixed for a further minute at 50 rpm. The mixture was heated using direct steam injection and once the temperature reached 50° C., the screw speed was increased to 150 rpm. Once the temperature reached 68° C. working continued for a further 90 seconds and then the speed decreased back to 50 rpm which was continued for 7.5 minutes. The product was discharged from the cooker into a variety of containers for sampling and further use.

Once cooled to ambient temperature, the mozzarella cheese produced was described as having a very nice texture and a lovely fresh flavour. During cooking the curd mass was described as good for working and lacked off-odours. A second batch of cheese (using curd of pH 5.4 from run of Table 5) was prepared with similar results. The composition of the cheese samples is shown in Table 7.

TABLE 7
Composition of Mozzarella cheese samples

| | Prepared with curd | Prepared with curd | Prepared from batch |
|---|---|---|---|
| | from renneting at | from renneting at | renneted curd at |
| Sample | 15° C. & pH 5.4 | 20° C. & pH 5.4 | 10° C. & pH 6.7 |
| Moisture % | 53.4 | 52.6 | 54.1 |
| Fat % | 21.1 | 20.9 | 20.8 |
| Protein % | 23.41 | 23.99 | 22.65 |
| (TN × 6.38) | | | |
| Lactose % | 0.33 | 0.61 | 0.46 |
| Salt % | 1.39 | 1.36 | 1.41 |
| pH | 5.66 | 5.68 | 5.69 |

It was demonstrated that satisfactory renneted curd with appropriate calcium content could be prepared from fresh milk using a flow device with a nominal hold up time of approximately 500 s. It was also demonstrated that fresh milk could be converted to mozzarella cheese (ready for freezing) within an elapsed time of about 30 minutes. This process demonstrated the surprising reduction in processing time over traditional cheese making methods, especially mozzarella cheese making, which traditionally takes a week or more to complete (at the point where the cheese is ready to be chilled or frozen for storage).

The mozzarella cheese prepared from both samples (runs from Tables 4 & 5, pH 5.4, 15° C. and pH 5.4, 20° C.) was shredded at room temperature and placed on the top of pizzas prepared consistent with Pizza Hut's evaluation methods. The pizzas comprised a 12 inch diameter pan base, 206 g shredded cheese uniformly sprinkled on 90 g tomato sauce spread uniformly over the dough base and cooked at 250° C. for 7 mm through a Lincoln impinger oven.

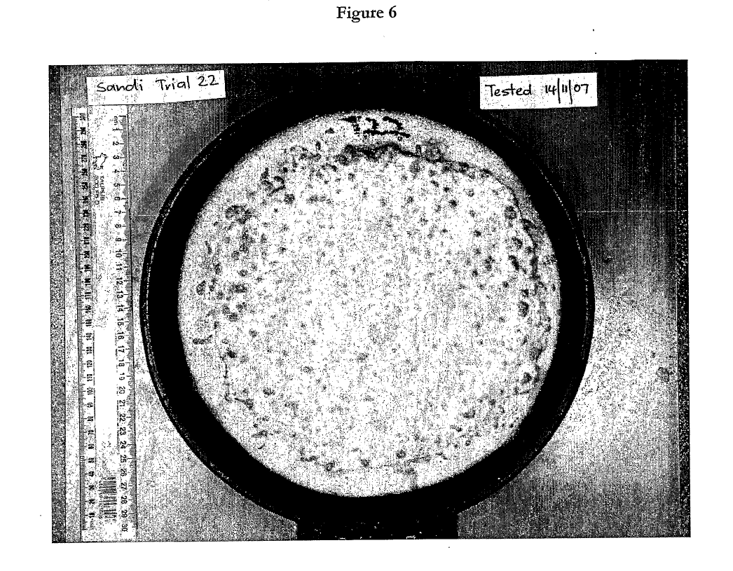

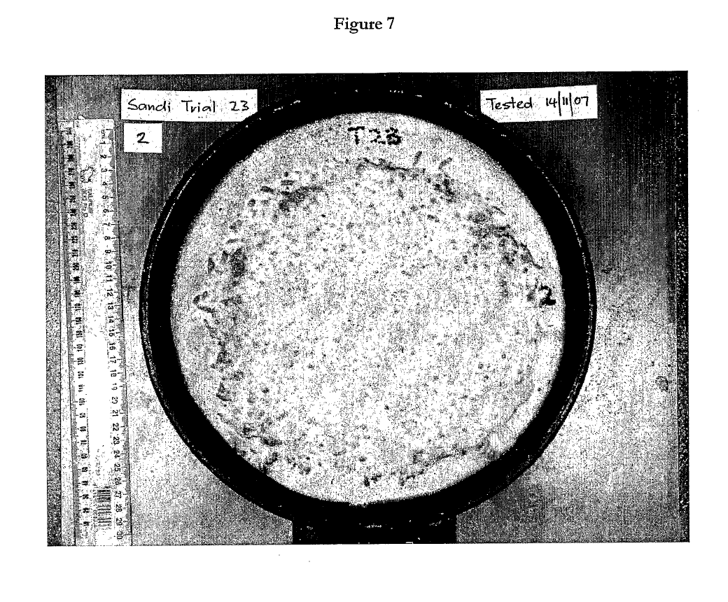

The two pizzas from this invention [see FIG. 6 for a representative example] were compared alongside a control pizza [FIG. 7] prepared using a mozzarella cheese sample (control) that was prepared using the same formulation and equipment as above, with the exception that the milk was batch renneted by adding the enzyme to skim milk at 10° C. (at pH 6.7) and holding in a vessel for 26 h, before processing through the plant of FIG. 2 with acid dosing to pH 5.4.

The three cooked pizzas were evaluated for blister coverage, blister size, skinning, blister colour, background colour, melt appearance, oil off, stretch length, stretch type, tenderness (initial and post chewing) and flavour. With the exception of some minor defects (blister colour and coverage being a little light and slightly unmelted underneath the molten cheese) the functionality of cheese made using the continuous renneting process was acceptable and met commercial standards for after-bake functionality.

In general, all pizzas (with the exception of blister colour—too light) had acceptable characteristics. Blister colour may be manipulated by a variety of known methods including adjusting the residual lactose in the cheese. Overall the sample cheeses of this invention were commercially acceptable as a Mozzarella cheese topping for pizzas.

### Example 4

### Checking Overall Residence Time Distribution of Curd Preparation System

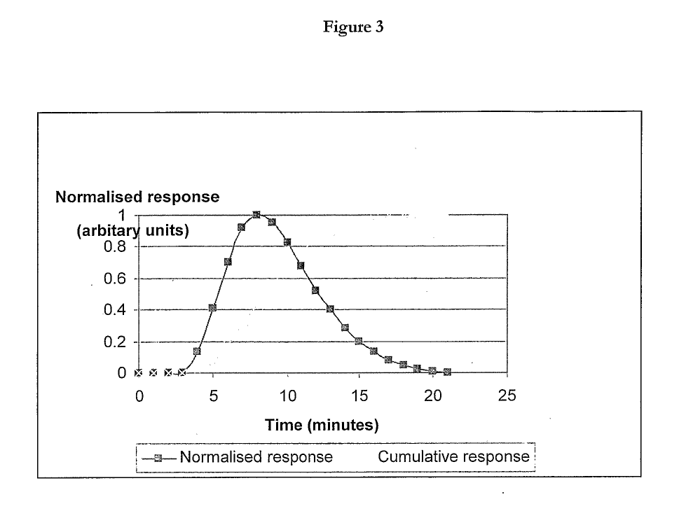

The overall residence time distribution was measured using the pulse technique. The plant was run on cold water in the configuration shown in FIG. 2. (Acid and enzyme dosing systems and the steam supply were switched off.) While running steadily on water from one silo, the water supply was interrupted for a few seconds by diverting to a second supply silo containing brine. The supply was then diverted back to the supply from the water silo. The conductivity of the flow of the pulse of brine emerging from the decanter was monitored. FIG. 3 shows the resulting distribution curve of the pulse of brine through the process. An average hold up time of about 500 seconds was noted (50% of pulse passes).

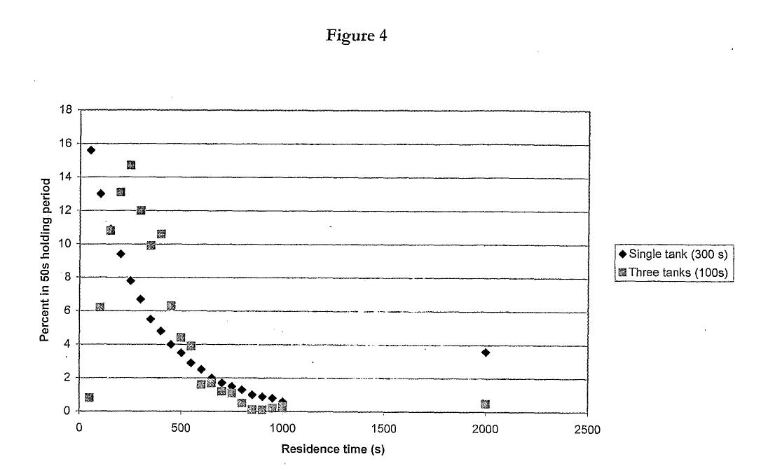

The actual residence time distribution (FIG. 3) can be compared with the theoretical distribution of perfectly mixed reactors in FIG. 4. The practical enzyme reaction system demonstrated a combination of plug flow and CSTR elements coupled in series.

### Example 5

### Optimising Reactor Design for Efficient Enzyme Action

A numerical simulation was conducted to examine the residence time distributions for a single

CSTR with 300 s space velocity (τ) and three CSTR reactors in series each with τ of 100 s. The residence time distribution for an ideal CSTR is given by

$$\frac{1}{τ} {e}^{- \frac{t}{τ}}$$

where t is the time (s) and τ(s) is the space velocity (defined as the nominal reactor volume (m³) divided by the flowrate (m³/s)).

The results showed that a single CSTR with 300 s nominal holding time would result in a very broad time distribution of samples with about 15% of material emerging with <50 s residence time and nearly 4% residing for >1000 s. In contrast, three CSTRs in series with the same equivalent holding time (3×100 s) reduces the residence time distribution surprisingly with now only about 1% residing for <50 s and only about 0.5% residing >1000 s.

All references and citations throughout the specification, including patent specifications, are hereby incorporated in their entirety.

### INDUSTRIAL APPLICATION

The process of the present invention and cheese made using the processes have commercial application in the cheese making industry. In particular, mozzarella cheese made by this process has application in the pizza making industry that utilises mozzarella and mozzarella-like (pizza) cheese in significant quantities. This invention dramatically reduces the time required to convert milk into fully functional cheese, especially mozzarella and mozzarella-like (pizza) cheese.

It is not the intention to limit the scope of the invention to the abovementioned examples only. As would be appreciated by a skilled person in the art, many variations are possible without departing from the scope of the invention as set out in the accompanying claims.

1. A continuous process for making cheese comprising the steps
a) adjusting the temperature of a protein containing starting milk to between about 5° C. and 28° C.;
b) acidifying the temperature adjusted starting milk of step a) to reduce the pH to between about 4.6 and 6.2;
c) adding an enzyme capable of converting kappa casein into para-kappa casein to the acidified, temperature adjusted starting milk of step b) and mixing rapidly to evenly disperse the enzyme throughout the starting milk;
d) passing the mixture of step c) through a flow device for between about 1 and 1000 seconds to allow the enzyme to react with the milk protein;
e) heating the enzyme-reacted mixture of step d) to between about 30° C. and 55° C. to initiate coagulation and produce discrete curd particles within the flow device;
f) draining the curd particles from the whey; and
g) further processing the curd particles to make a cheese product.

2. A continuous process as claimed in claim 1, wherein the protein containing starting milk comprises milk or reconstituted milk selected from the group consisting of whole fat milk, whole milk retentate/concentrate, semi-skimmed milk, skimmed milk, skimmed milk retentate/concentrate, buttermilk, buttermilk retentate/concentrate, whey protein retentate/concentrate, any other product made from milk and combinations thereof.

3. A continuous process as claimed in claim 2, wherein one or more powders, selected from whole milk powder, skimmed milk powder, milk protein concentrate powder, whey protein concentrate powder, whey protein isolate powder and buttermilk powder or other powders made from milk, reconstituted or dry, singularly or in combination are selected as the starting milk or are added to the starting milk defined in claim 2.

4. (canceled)

5. A continuous process as claimed in claim 1, wherein the starting milk is temperature adjusted to between 10° C. and 22° C. in step a).

6. (canceled)

7. A continuous process as claimed in claim 1, wherein the temperature adjusted starting milk of step a) is acidified in step b) using an acidulant selected from the group consisting of a food grade acid, a fermentate and combinations thereof.

8. (canceled)

9. A continuous process as claimed in claim 1, wherein the starting milk is acidified in step b) to a pH of between 5.2 and 6.0.

10. A continuous process as claimed in claim 7, wherein the food grade acid is selected from the group consisting of hydrochloric acid, sulphuric acid, acetic acid and lactic acid.

11. A continuous process as claimed in claim 7, wherein the fermentate comprises a dairy growth medium stream to which starter culture has been added.

12. A continuous process as claimed in claim 11, wherein the starter culture is a mesophilic or thermophilic lactose fermenting bacteria or a mixture thereof and is added at 0.0005 to 0.2% of the milk volume.

13. (canceled)

14. A process as claimed in claim 11, wherein a starter culture stream is prepared by heating milk selected from skim milk, skimmilk retentate or reconstituted skimmilk, to approximately 26° C. to 45° C., adding the culture and allowing fermentation to proceed until the pH of the skimmilk has reached pH 4.5-6.0.

15. (canceled)

16. A continuous process as claimed in claim 1, wherein the enzyme added at step c) is Fromase XL₇₅₀ or ChyMax.

17. (canceled)

18. A continuous process as claimed in claim 1, wherein the flow device comprises a tubular flow passage or arrangement of flow-linked vessels whose volumetric capacity provides sufficient residence time for the reaction to occur.

19. A continuous process as claimed in claim 1, wherein the residence time in the flow device in step d) is between about 10 and 750 seconds.

20. (canceled)

21. A continuous process as claimed in claim 1, wherein the combination of protein concentration, temperature, pH, reaction time and enzyme concentration of the acidified enzyme containing starting milk at steps c) and d) are selected to avoid coagulation prior to reaching the cooking stage (step e).

22. A continuous process as claimed in claim 21, wherein the temperature of the enzyme containing starting milk is less than 28° C.

23. (canceled)

24. A continuous process as claimed in claim 1, wherein in step e), the enzyme reacted mixture of step d) is heated/cooked to a temperature of between about 30° C. and 50° C., using direct or indirect heating means to coagulate the protein and form coagulated curd particles.

25. A continuous process as claimed in claim 24, wherein the enzyme reacted mixture of step d) is heated/cooked to a temperature of between about 40 and 46° C.

26. A continuous process as claimed in claim 1, wherein the coagulated curd particles are drained in step f) by a separator selected from the group consisting of a sieve, decanter and membrane apparatus.

27. A continuous process as claimed in claim 1, wherein the cheese product produced in step g) comprises a soft, semi-soft, hard or extra-hard cheese.

28. A continuous process as claimed in claim 27, wherein the cheese comprises cheddar, gouda, parmesan or mozzarella cheese.

29. A continuous process as claimed in claim 27, wherein the curd is mechanically worked in step g) to heat and stretch the curd to produce a mozzarella cheese.

30.-33. (canceled)
